(19) United States
(12) Patent Application Publication
(10) Pub. No.: US 2010/0134229 A1
(43) Pub. Date: Jun. 3, 2010

(54) TRANSMISSION-LINE TRANSFORMER AND AMPLIFIER UNIT HAVING THE SAME

(75) Inventor: Takekatsu UEKI, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki-shi (JP)

(21) Appl. No.: 12/628,695

(22) Filed: Dec. 1, 2009

(30) Foreign Application Priority Data
Dec. 2, 2008 (JP) 2008-307551

(51) Int. Cl. H01F 21/06

(52) U.S. Cl. 336/119

(57) ABSTRACT

A transmission-line transformer which includes a core composed of a magnetic substance, and a transmission line, wherein the core includes a body having the transmission line wound therearound, and a movable unit which can move relative to the body in keeping contact therewith, wherein the transmission-line transformer is provided on a substrate, at least a portion of the movable unit (a head, for example) is located on the opposite side of the substrate, while placing the body in between, and the movable unit is moved relative to the body, by an operation effected to at least the portion (the head, for example).

This application is based on Japanese patent application No. 2008-307551 the content of which is incorporated hereinto by reference.

### BACKGROUND

1. Technical Field

The present invention relates to a transmission-line transformer and an amplifier unit.

2. Related Art

Wide-band amplifier which amplifies input signals ranging over a wide band (40 MHz to 1 GHz, for example) generally has a transmission-line transformer matched in the impedance over a wide band, connected to the input end and to the output end. The transmission-line transformer is connected to the wide-band amplifier, for the purpose of ensuring impedance matching between an inner amplifier unit (field effect transistor) of the wide-band amplifier and an external transmission line (cable or other units).

FIG. 13 and FIG. 14 are drawings illustrating an example of the transmission-line transformer. FIG. 13 is a front elevation, and FIG. 14 is a side elevation. A transmission-line transformer 100 illustrated in FIG. 13 and FIG. 14 is configured to have a core 101, a transmission line 102 wound around the core 101, a base 103 having the core 101 placed thereon, and terminals 104 provided to the base 103. The core 101 is composed of a magnetic substance. FIG. 13 and FIG. 14 exemplifies the spectacle-shaped core 101. The transmission line 102 is a bifiler (two combined wires) or a trifiler (three combined wires). The ends of the transmission line 102 are wound around the terminals 104 and soldered thereto. The terminals 104 function as an output transformer of an amplifier unit. This sort of transmission-line transformer 100 is used while being mounted on a circuit substrate 105.

The transmission-line transformer 100 may readily be given as a small-sized one having a high characteristic impedance, by modifying structure (route, and so forth) of the transmission line 102 depending on a desired characteristic impedance. In other words, the transmission-line transformers having uniform characteristics may be obtained without special tuning. In addition, the transmission-line transformer contributes also to make characteristics of the amplifier unit uniform, when mounted on the circuit substrate of the amplifier unit.

A transmission-line transformer having a spectacle-shaped core, similar to that illustrated in FIG. 13 and FIG. 14, is disclosed in Japanese Laid-Open Patent Publication No. H10-116733.

Alternatively, Japanese Laid-Open Patent Publication No. H5-315146 discloses a variable-inductance coil device having a resin-made bobbin having a coil wound therearound, an outer magnetic component disposed so as to surround the bobbin, and an inner magnetic component screwed into the bobbin. According to the description, the inductance of the coil device may be varied, by moving at least one of the outer magnetic component, the bobbin (“coil component 4” in the description), and the inner magnetic component.

Japanese Laid-Open Patent Publication No. H11-238626 discloses a variable-inductance instrument having a vertically-paired lateral cores which extend in the transverse direction, and a laterally-paired vertical cores which extend in the vertical direction and have coils respectively wound therearound. In the variable-inductance instrument, the upper ends of the vertical cores are brought into contact with the bottom surface of the upper lateral core, and the lower ends of the vertical cores are brought into contact with the top surface of the lower lateral core, so that a loop core as a whole is configured by four these core components. According to the description, the inductance of the variable-inductance instrument may be varied, by adjusting the distance between the laterally-paired vertical cores having the coils wound therearound.

As described in the above, the transmission-line transformer may be adjustable in the impedance characteristics thereof, by varying the structure of the transmission lines depending on desired characteristic impedance, with some actual problems remained unsolved.

The amplifier unit per se may occasionally cause mismatching of impedance, due to variations in the internal amplifier unit of the wide-band amplifier, other components on the circuit substrate, and the transmission-line transformer per se.

The transmission-line transformer may nearly be idealized in the impedance conversion ratio, by modifying structure of the core, structure of the transmission line, and a style of winding of the transmission line. However on the mass-production basis, the impedance conversion ratio of the resultant transmission-line transformer may not always be constant, while being affected by variation in the materials, variation in the process of assembling (position of winding of the transmission line, tightness of winding, and so forth). Another problem is that the transmission-line transformer (FIG. 13, FIG. 14) such as disclosed in Japanese Laid-Open Patent Publication No. H10-116733 is not adjustable in the impedance characteristics once it was manufactured.

Mounting of the transmission-line transformer on the circuit substrate of the amplifier unit may, therefore, result in a large variation in the characteristics of the wide-band amplifier (in particular, input/output return loss characteristics), due to differences in matching with the peripheral components. Such mismatching of impedance may occasionally induce reflective wave, and consequent degradation of transmission efficiency in association with the reflective wave. For this reason, it is desired for the transmission-line transformer (in a state of mounting on the circuit substrate) per se to be adjustable in the impedance characteristics.

According to the technique disclosed in Japanese Laid-Open Patent Publication No. H5-315146, since the coil device is configured to be variable in the inductance, so that also impedance may vary in association with changes in the inductance. However, the technique disclosed in this document has problems to be solved, with respect to operability in varying the inductance, and the degree of freedom of arrangement (layout) of the coil device, as described in the next.

First, an operation of moving the inner magnetic component screwed into the bobbin in the axial direction thereof is effected from side direction of the coil device, using a hand tool such as hexagon wrench. The operation was, however, not easy when a small-sized coil device was fixed on the substrate, due to interference between the hand which performs the operation and the substrate. Moreover, it was necessary for the convenience of operation to keep, alongside the coil device on the substrate, an unoccupied space where any other instruments are not allowed to be arranged therein. In short, the problems of operability and the degree of freedom of layout have remained unsolved.

Japanese Laid-Open Patent Publication No. H5-315146 gives no description on a method of moving the outer magnetic component and the bobbin (“coil component 4” in the description), so that how to move them is unclear. Accordingly, it is not possible to judge excellence of the operability for moving the outer magnetic component and the bobbin.

On the other hand, Japanese Laid-Open Patent Publication No. H11-238626 gives no description on how to move the vertical cores. Even the mode of connection between the vertical cores and the lateral cores is not explained. It is, therefore, impossible to judge the operability of the vertical cores.

As described in the above, the techniques disclosed in Japanese Laid-Open Patent Publication Nos. H5-315146 and H11-238626 have been questionable about the operability in the process of tuning the impedance characteristics.

### SUMMARY

According to the present invention, there is provided a transmission-line transformer which includes a core composed of a magnetic substance and a transmission line. The core includes a body having the transmission line wound therearound, and a movable unit which can move relative to said body in keeping contact therewith. The transmission-line transformer is provided on a substrate. At least a portion of the movable unit is located on the opposite side of the substrate, while placing the body in between, and the movable unit is moved relative to the body, by an operation effected to at least the portion.

According to the transmission-line transformer, the impedance characteristics may be adjustable by moving the movable unit relative to the body.

Since at least a portion of the movable unit is located on the opposite side of the substrate, while placing the body in between, and the movable unit is moved relative to the body, by an operation effected to at least the portion, so that the operability of the movable unit, that is, the operability in the process of tuning the impedance characteristics may be improved. This is because the hand which performs the operation may be made no more interferential with the substrate.

Moreover, the degree of freedom of layout of the transmission-line transformer on the substrate may be improved. This is because the movable unit is now movable relative to the body, by an operation effected to the portion located on the opposite side of the substrate, while placing the body in between, and consequently it is no more necessary to leave a space unoccupied alongside the transmission-line transformer, for the convenience of operation for tuning.

According to the present invention, there is provided also a transmission-line transformer which includes a core composed of a magnetic substance, and a transmission line. The core includes a body having the transmission line wound therearound, and a movable unit which can move relative to said body in keeping contact therewith. The movable unit is disposed in a guide way which is formed in the body, so as to be movable along the guide way by a push operation.

According to the transmission-line transformer, the impedance characteristics may be adjustable by moving the movable unit relative to the body.

Since the movable unit is disposed in the guide way which is formed in the body, so as to be movable along the guide way by a simple operation such as a push operation, so that the operability of the movable unit, that is, the operability in the process of tuning the impedance characteristics may be improved.

According to the present invention, there is provided still also a transmission-line transformer which includes a core composed of a magnetic substance, and a transmission line. The core includes a body having the transmission line wound therearound, and a movable unit which can move relative to said body in keeping contact therewith. The transmission-line transformer is provided on a substrate. The movable unit is provided at a position accessible for a moving operation from the side opposite to the substrate with reference to the transmission-line transformer.

According to the transmission-line transformer, the impedance characteristics may be adjustable by moving the movable unit relative to the body.

Since the movable unit is provided at a position accessible for a moving operation from the side opposite to the substrate with reference to the transmission-line transformer, so that the operability of the movable unit, that is, the operability in the process of tuning the impedance characteristics may be improved. This is because the hand which performs the operation may be made no more interferential with the substrate.

In addition, the degree of freedom of the layout of the transmission-line transformer on the substrate may be improved. This is because the movable unit is now movable from the side opposite to the substrate, and consequently it is no more necessary to leave a space unoccupied alongside the transmission-line transformer, for the convenience of operation for tuning.

According to the present invention, there is provided still also an amplifier unit which includes the transmission-line transformer of the present invention, and a wide-band amplifier connected to the transmission-line transformer.

According to the present invention, the operability in the process of tuning the impedance characteristics may be improved.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a front elevation of a transmission-line transformer of a first embodiment;

FIG. 2 is a side elevation of the transmission-line transformer of the first embodiment;

FIG. 3 is a rear elevation of the transmission-line transformer of the first embodiment;

FIG. 4 is a plan view of the transmission-line transformer of the first embodiment;

FIG. 5 is a front elevation illustrating a movable unit of a core provided to the transmission-line transformer of the first embodiment;

FIG. 6 is an equivalent circuit diagram of the transmission-line transformer of the first embodiment;

FIG. 7 is a block diagram illustrating a configuration of an amplifier unit of the first embodiment;

FIG. 8 is a front elevation of a transmission-line transformer of a second embodiment;

FIG. 9 is a side elevation of the transmission-line transformer of the second embodiment;

FIG. 10 is a front elevation of a transmission-line transformer of a third embodiment;

FIG. 11 is a side elevation of the transmission-line transformer of the third embodiment;

FIG. 12 is a drawing illustrating an effect of the transmission-line transformer of the third embodiment;

FIG. 13 is a front elevation illustrating a transmission-line transformer disclosed in Japanese Laid-Open Patent Publication No. H10-116733; and

FIG. 14 is a side elevation of the transmission-line transformer disclosed in Japanese Laid-Open Patent Publication No. H10-116733.

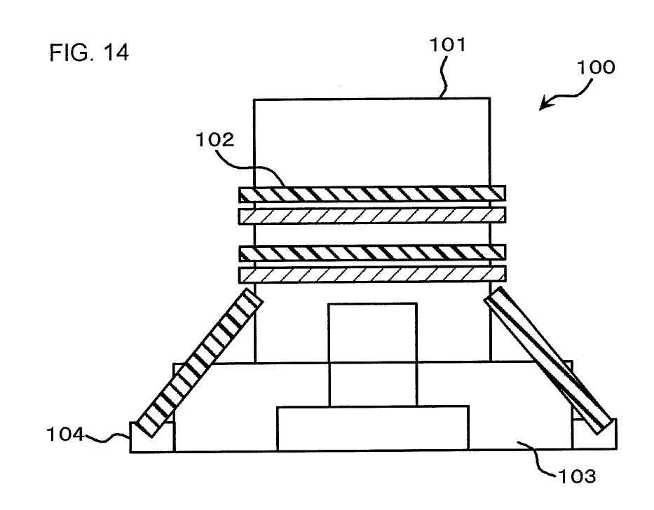

### DETAILED DESCRIPTION

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be explained below, referring to the attached drawings. Note that any similar constituents will be given with the same reference numerals or symbols in all drawings, and explanations therefor will not be repeated.

### First Embodiment

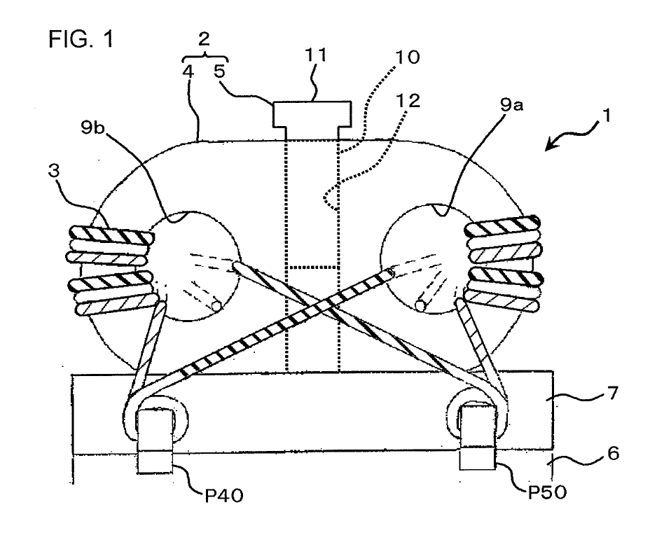

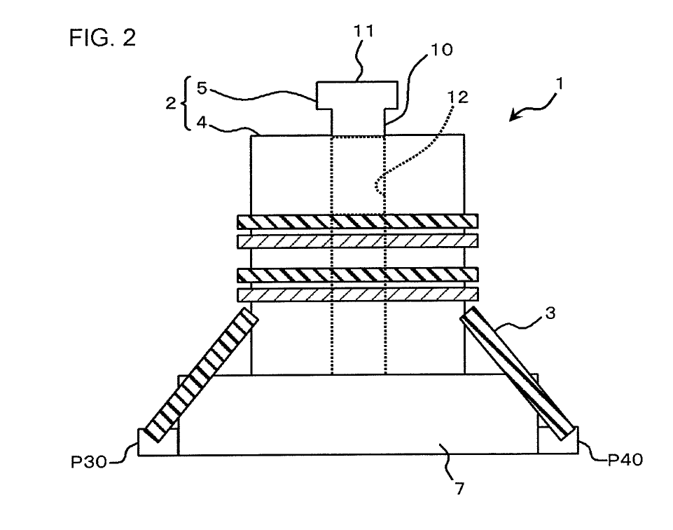

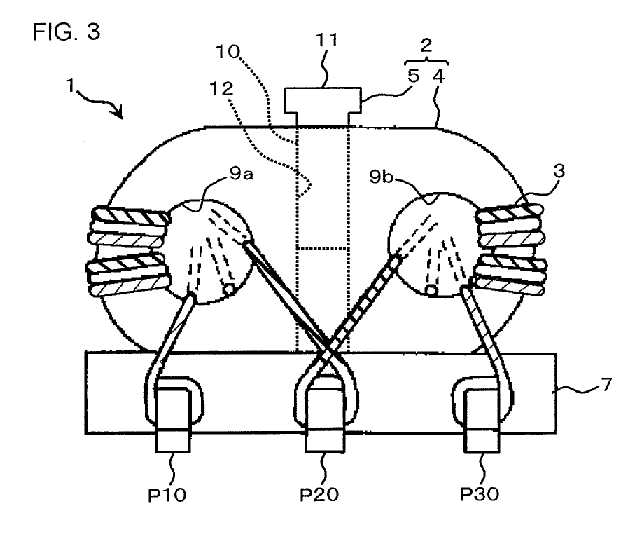

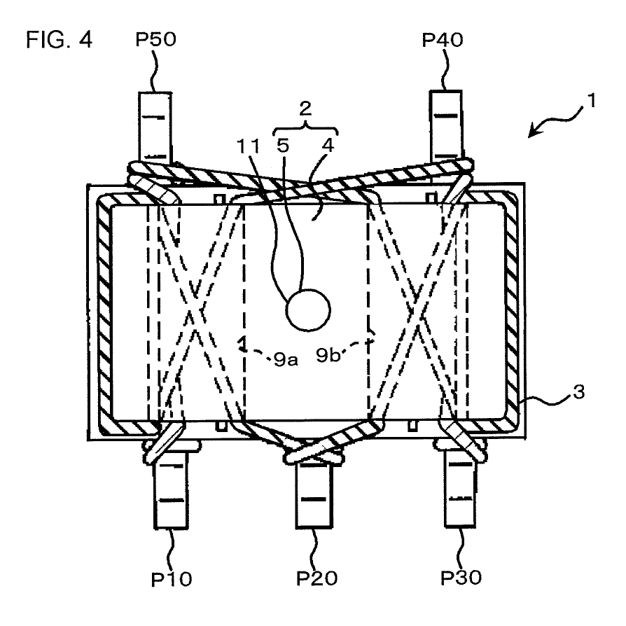

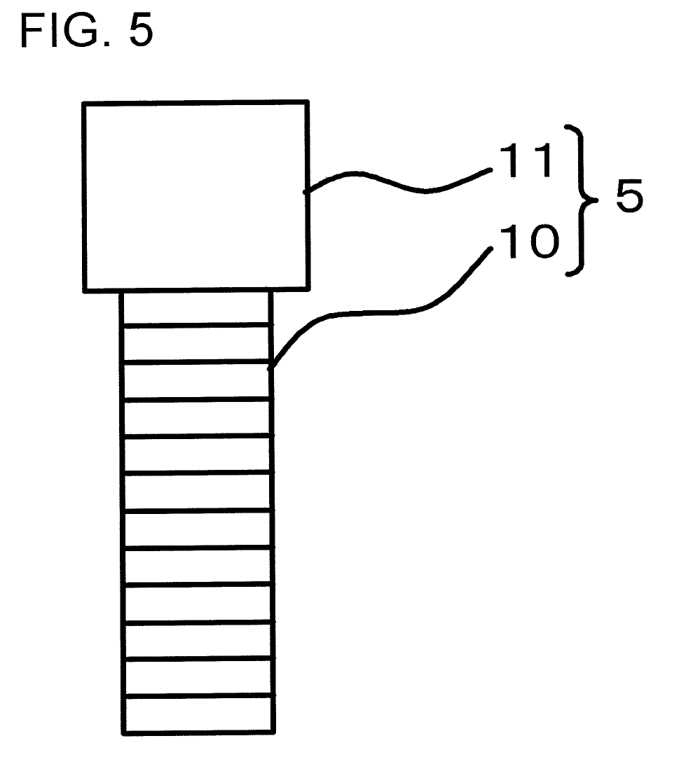

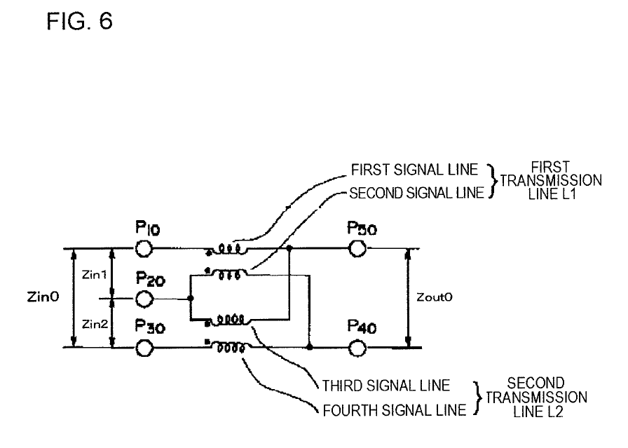

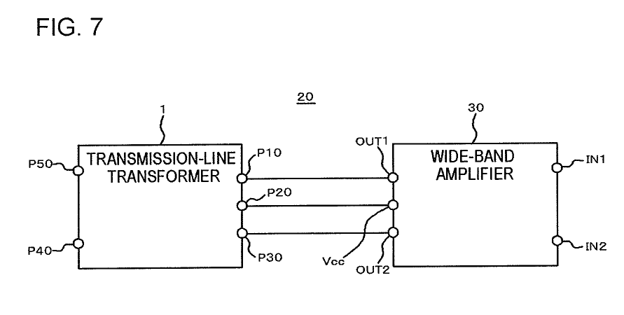

FIG. 1 to FIG. 4 are drawings illustrating a transmission-line transformer 1 of a first embodiment. FIG. 1 is a front elevation, FIG. 2 is a side elevation, FIG. 3 is a rear elevation, and FIG. 4 is a plan view. FIG. 5 is a front elevation illustrating a movable unit 5 of a core 2 provided to the transmission-line transformer 1. FIG. 6 is an equivalent circuit diagram of the transmission-line transformer 1. FIG. 7 is a block diagram illustrating a configuration of an amplifier unit 20 of the first embodiment. The transmission-line transformer 1 has a core 2 composed of a magnetic substance, and a transmission line 3. The core 2 is composed of a body 4 having the transmission line 3 wound therearound, and a movable unit 5 which can move relative to the body 4 in keeping contact therewith. The transmission-line transformer 1 is provided on a substrate (circuit substrate 6). At least a part (a head 11, for example) of the movable unit 5 is located on the opposite side of a substrate, while placing the body 4 in between. The movable unit 5 is moved by an operation effected to at least the part (the head 11, for example), relative to the body 4. The amplifier unit 20 has the transmission-line transformer 1, and a wide-band amplifier 30 connected to the transmission-line transformer 1. Details will be given below.

First, a configuration of the transmission-line transformer 1 will be explained.

As illustrated in FIG. 1 to FIG. 4, the transmission-line transformer 1 is configured to have the core 2 composed of a magnetic substance, the transmission line 3 wound around the core 2, a base 7 having the core 2 placed thereon, and terminals P10, P20, P30, P40, P50 provided to the base 7. Thus-configured transmission-line transformer 1 is provided on the circuit substrate (substrate) 6 as illustrated in FIG. 1. The transmission-line transformer 1 is typically bonded to the circuit substrate 6.

The core 2 is composed of the body 4 having the transmission line 3 wound therearound, and the movable unit 5 which can move relative to the body 4 in keeping contact therewith.

The body 4 typically has a spectacle shape as illustrated in FIG. 1, and has a lateral pair of openings 9a, 9b respectively formed so as to depth-wisely penetrate the body 4. The top surface and the bottom surface of the body 4 are respectively formed flat, and parallel with each other. Also the front surface and the back surface of the body 4 are respectively formed flat, and parallel with each other. The front surface and the back surface are respectively formed perpendicular to the top surface and the bottom surface. The both lateral side faces of the body 4 are respectively formed to have an arc profile which swells outwardly.

A bifiler (two combined wires) or a trifiler (three combined wires) may typically be used as the transmission line 3. In this embodiment, the transmission line 3 is typically composed of a bifiler.

The transmission-line transformer 1 is typically connected to the output side of the wide-band amplifier 30, and functions as an output transformer of the amplifier unit 20. This sort of transmission-line transformer 1 has a balanced side disposed on the side of output terminals OUT1, OUT2 of the wide-band amplifier 30, and an unbalanced side connected to the transmission line on the output side (not illustrated). Among the terminals P10, P20, P30, P40, P50, the terminals P10, P20, P30 are input terminals disposed on the balanced side, and the terminals P40, P50 are output terminals disposed on the unbalanced side.

Of the transmission line 3, it is now defined that a line connecting the terminals P10 and P50 is denoted as a first signal line, and a line connecting the terminals P20 and P40 is denoted as a second signal line. The first and the second signal lines are collectively denoted as a first transmission line L1. On the other hand, a line connecting the terminals P20 and P50 is denoted as a third signal line, and a line connecting the terminals P30 and P40 is denoted as a fourth signal line. The third and the fourth signal lines are collectively denoted as a second transmission line L2 (FIG. 6).

The first transmission line L1 (FIG. 6) composed of the first and the second signal lines, and the second transmission line L2 (FIG. 6) composed of the third and the fourth signal lines are respectively configured by a bifiler (two-core parallel lines). One end of the first signal line composing the first transmission line L1 is connected to the input terminal P10, while being wound therearound and soldered thereto, and the other end is allowed to pass through the opening 9a of the body 4, and then connected to the output terminal P50, while being wound therearound and soldered thereto. One end of the second signal line is connected to the input terminal P20, while being wound therearound and soldered thereto, and the other end is allowed to pass through the opening 9b of the body 4, and then connected to the output terminal P40, while being wound therearound and soldered thereto. The first signal line is typically allowed to pass through the opening 9a three times so as to be wound around the body 4, and the second signal line is typically allowed to pass through the opening 9b three times so as to be wound around the body 4.

Moreover, one end of the third signal line composing the second transmission line L2 is connected to the input terminal P20, while being wound therearound and soldered thereto, and the other end is allowed to pass through the opening 9a, and then connected to the output terminal P50, while being wound therearound and soldered thereto. One end of the fourth signal line is connected to the input terminal P30, while being wound therearound and soldered thereto, and the other end is allowed to pass through the opening 9b, and then connected to the output terminal P40, while being wound therearound and soldered thereto. The third signal line is typically allowed to pass through the opening 9a three times so as to be wound around the body 4, and the fourth signal line is typically allowed to pass through the opening 9b three times so as to be wound around the body 4. As described in the above, for example, the first and the third signal lines are allowed to pass through the opening 9a of the body 4, and the second and the fourth signal lines are allowed to pass through the opening 9b of the body 4.

The transmission line 3 is wound while being kept away from the top surface of the body 4. Also any other foreign matters are not allowed to reside on the top surface of the body 4. Accordingly, the top surface of the core 2 is given flat expect for the region thereof where the movable unit 5 is disposed. By virtue of this configuration, the transmission-line transformer 1 is configured to have a geometry which is convenient to be mounted using an automatic mounter onto the circuit substrate 6.

In this embodiment, the movable unit 5 is typically formed to have a bolt shape, as illustrated in FIG. 5. More specifically, the movable unit 5 is typically configured to have a male threaded portion which may be screwed into the body 4, and a head 11 having a larger diameter than that of the male threaded portion 10.

On the other hand, a female threaded portion 12 is formed to the body 4 so as to be opened in the top surface thereof. The female threaded portion 12 may be extended through the body 4 from the top to the bottom thereof as illustrated in FIG. 1 and FIG. 2, or may be formed only to a depth which falls short of the bottom end.

The female threaded portion 12 of the body 4 is screwed with the male threaded portion 10 of the movable unit 5. Accordingly, the position of the movable unit 5 relative to the body 4 may be adjustable by controlling the depth of screwing. The impedance characteristics of the transmission-line transformer 1 may thus be tunable by adjusting the position of the movable unit 5.

The female threaded portion 12 is formed typically so as to align the axial direction thereof perpendicular to the circuit substrate 6. Accordingly, by controlling the depth of screwing of the movable unit 5 relative to the body 4, the movable unit 5 is vertically moved relative to the circuit substrate 6.

The head 11 of the movable unit 5 typically has a notch formed therein, which is allowed for engagement with a hand tool such as screw driver for rotating the movable unit 5. Consequently, the head 11 functions as an adjusting operation unit for adjusting position of the movable unit 5 relative to the body 4. The head 11 as the adjusting operation unit is disposed at the end of the movable unit 5 opposite to the circuit substrate 6, as illustrated in FIG. 1 and FIG. 2. Moreover, the head 11 as the adjusting operation unit is projected out from the body 4, in the direction opposite to the circuit substrate 6. In other words, the head 11 is located on the opposite side of the circuit substrate 6 while placing the body 4 in between. Accordingly, the operation for moving the movable unit 5 may be effected from the side opposite to the circuit substrate 6, with reference to the transmission-line transformer 1.

The movable unit 5 configures a portion of the core 2 while leaving a route of winding of said transmission line unobstructed. Since the movable unit 5 is disposed so as not to obstruct the route of winding of the transmission line 3 in this way, the transmission line 3 may be prevented from undesirably inhibiting the operation for moving the movable unit 5, while suppressing a problem in that the route of winding of the transmission line 3 is affected as the movable unit 5 moves.

As for materials and characteristics, the core 2 is typically composed of an alloy which mainly contains iron, together with nickel, zinc and copper, and has a magnetic permeability of approximately 290.

The transmission-line transformer 1 of this embodiment is different from the transmission-line transformer disclosed in Japanese Laid-Open Patent Publication No. H10-116733, in that it has the movable unit 5, and the female threaded portion 12 allowing the movable unit 5 screwed therein, but is configured in other aspects similarly to the transmission-line transformer of the publication.

Next, a configuration of the amplifier unit 20 having the transmission-line transformer 1 will be explained.

As illustrated in FIG. 7, the amplifier unit 20 has the transmission-line transformer 1, and the wide-band amplifier 30 connected to the transmission-line transformer 1.

The wide-band amplifier 30 has a first input terminal IN1 and second input terminal IN2, a power source terminal Vcc, a first output terminal OUT1 and a second output terminal OUT2. Of these, the first output terminal OUT1 is connected with the terminal P10 of the transmission-line transformer 1, and the second output terminal OUT2 is connected with the terminal P30 of the transmission-line transformer 1, and the power source terminal Vcc is connected with the terminal P20 of the transmission-line transformer 1.

The first input terminal IN1 and the second input terminal IN2 are connected, via a transmission-line transformer (not illustrated) on the input side, to a transmission line (not illustrated) on the input side, which is typically configured by an unbalanced line such as coaxial line. The terminals P40 and P50 of the transmission-line transformer 1 are connected to a transmission line (not illustrated) on the output side, which is typically configured by an unbalanced line such as coaxial line.

Operations will be explained below.

The impedance characteristics of the transmission-line transformer 1 may be tunable by adjusting the depth of screwing of the movable unit 5 relative to the body 4. More specifically, the operation may be effected using a hand tool such as screw driver. Note that FIG. 1 and FIG. 3 illustrate a state where the movable unit 5 is screwed deeper as illustrated in FIG. 2.

The operation for controlling the depth of screwing of the movable unit 5 herein may be effected from the side opposite to the circuit substrate 6, with reference to the transmission-line transformer 1. Accordingly, the hand which performs the operation may be prevented from interfering with the circuit substrate 6. Also it is no more necessary to leave a space unoccupied alongside the transmission-line transformer, for the convenience of operation.

By controlling the position of the movable unit 5 relative to the body 4, load capacitance produced between the body 4 and the movable unit 5 may vary, and the magnetic field at around the core 2 may consequently vary. By virtue of these changes, the impedance characteristics of the transmission-line transformer 1 may be varied (to a degree of several ohms, for example). In this way, the impedance characteristics of the transmission-line transformer 1 may be tunable.

By tuning the impedance characteristics of the transmission-line transformer 1 as described in the above, reflection characteristics of the amplifier unit 20 having the transmission-line transformer 1 may be improved. The reflection characteristics of the amplifier unit 20 may be affected not a little by variation in characteristics of active elements and chip components owned by the amplifier unit 20, but may be improved so as to reduce the influences, by tuning the impedance characteristics of the transmission-line transformer 1. In short, not only adverse effects ascribable to variations in the characteristics of the transmission-line transformer 1 per se, but also those ascribable to variations in the characteristics of other elements, may be reduced.

According to the embodiment, effects described below may be obtained.

First, by moving the movable unit 5 relative to the body 4, the impedance characteristics of the transmission-line transformer 1 may be tunable to desired values.

Since the movable unit 5 is moved relative to the body 4, by an operation effected to the head 11 located on the opposite side of the circuit substrate 6 relative to the body 4, so that the operability of the movable unit 5, that is, the operability in the process of tuning the impedance characteristics may be improved. This is because the hand which performs the operation may be made no more interferential with the substrate 6.

Moreover, the degree of freedom of the layout of the transmission-line transformer 1 on the circuit substrate 6 may be improved. This is because the movable unit 5 is now movable by the operation effected to the head 11, and consequently it is no more necessary to leave a space unoccupied alongside the transmission-line transformer 1, for the convenience of operation for tuning.

Since the movable unit 5 configures a portion of the core 2 while leaving a route of winding of the transmission line 3 unobstructed, so that the transmission line 3 may be prevented from undesirably inhibiting the movement of the movable unit 5, and the operability of the movable unit 5 may further be improved, while suppressing a problem in that the route of winding of the transmission line 3 is affected as the movable unit 5 moves.

Referring now to the technique disclosed in Japanese Laid-Open Patent Publication No. H11-238626, characterized in that the vertical cores wound with the coil are moved, it has been necessary to set at least one end of the coil wound around the vertical cores free, so as to allow the amount of movement. Since one end of the coil is thus set free, so that movement of the vertical cores to the same position may not always locate one end of the coil to the same position in a highly reproducible manner. As a consequence, a problem arises in that it is difficult to constantly reproduce the same inductance characteristics even if the vertical cores are moved to the same position. In contrast, the transmission-line transformer 1 of this embodiment configures a portion of the core 2 while leaving a route of winding of the transmission line 3 unobstructed, so that such problem may be avoidable.

Since the movable unit 5 is screwed into the body 4, and the position thereof relative to the body 4 may be adjustable by controlling the depth of screwing, so that the depth of screwing of the movable unit 5 and the impedance characteristics may unequivocally be corresponded for each transmission-line transformer 1. In other words, the same depth of screwing gives the same impedance characteristics in a highly reproducible manner.

Since the movable unit 5 has the head 11, which is the adjusting operation unit for controlling the position relative to the body 4, at the end thereof opposite to the circuit substrate 6, the operability of the movable unit 5, that is, the operability in the process of tuning the impedance characteristics may further be improved.

Referring now to Japanese Laid-Open Patent Publication No. H5-315146, it has been difficult to mass-produce the coil device while ensuring a constant distance between the outer magnetic component and the inner magnetic component in a highly reproducible manner, because of the structure having both magnetic components placed apart from each other. An anticipated problem has been such that the product-wise variation in the distance between the outer magnetic component and the inner magnetic component results in product-wise variation in the characteristics of the coil devices per se. In contrast in the transmission-line transformer 1 of this embodiment, the movable unit 5 is made movable while being brought into contact with the body 4. Since there is no gap between the movable unit 5 and the body 4, the above-described problem may be avoidable.

### Second Embodiment

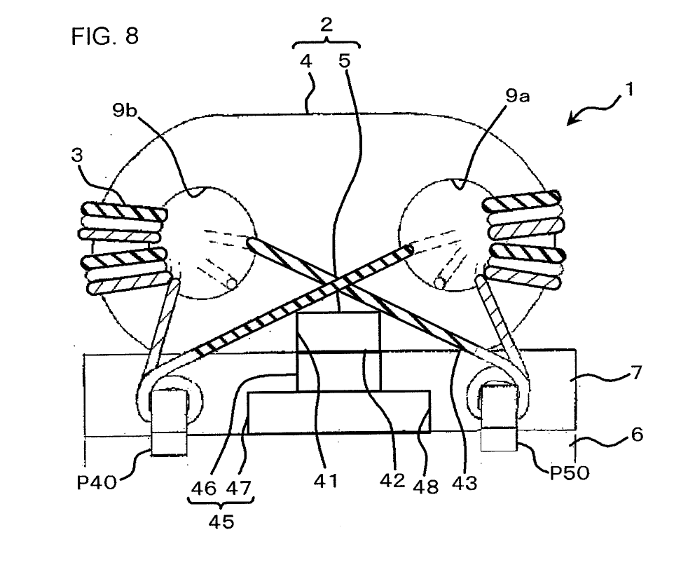

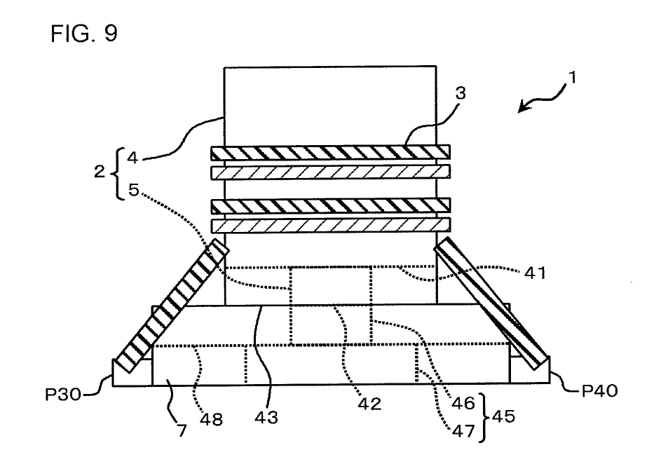

FIG. 8 and FIG. 9 are drawings illustrating a configuration of the transmission-line transformer 1 according to a second embodiment. FIG. 8 is a front elevation, and FIG. 9 is a side elevation.

The transmission-line transformer 1 of the second embodiment is configured similarly to as the transmission-line transformer 1 of the first embodiment, except for a configuration of the core 2.

As illustrated in FIG. 8 and FIG. 9, the body 4 in this embodiment has a guide way 41 formed therein, used for guiding the movable unit 5. The movable unit 5 is disposed in the guide way 41, so as to be movable along therewith by a push operation.

The guide way 41 is formed typically so as to extend from the front surface to the back surface of the body 4, as illustrated in FIG. 8 and FIG. 9. Accordingly, the movable unit 5 is configured to move in the depth-wise direction of the body 4.

The movable unit 5 in this embodiment is formed into a rectangular parallelepiped. The guide way 41 is formed as a long rectangle-sectioned trench (illustrated in FIG. 8 and FIG. 9 as a downwardly-opened trench), capable of allowing the movable unit 5 to be guided therewith in a contact state.

A surface 42 of the movable unit 5 on the circuit substrate 6 side thereof is aligned at the same level with a surface 43 of the body 4 on the circuit substrate 6 side thereof.

On the surface 42 of the movable unit 5, a movable unit base 45 is provided so as to be integrated with the movable unit 5. The movable unit base 45 has a small-sized portion 46 fixed on the surface 42 of the movable unit 5, and a large-sized portion 47 located on the circuit substrate 6 side of the small-sized portion 46, in an integrated manner. The small-sized portion 46 is formed to have dimensions in the lateral direction and in the depth-wise direction same with those of the movable unit 5 as illustrated in FIG. 8 and FIG. 9, and is bonded to the surface 42 of the movable unit 5. The large-sized portion 47 is formed to have the dimensions in the lateral direction and in the depth-wise direction larger than those of the movable unit 5 as illustrated in FIG. 8 and FIG. 9. The small-sized portion 46 and the large-sized portion 47 of the movable unit base 45 are respectively formed in rectangular parallelepiped. In the base (body base) 7, a base guide way 48 capable of guiding the movable unit base 45 in the depth-wise direction is formed so as to extend from the front surface to the back surface of the base 7.

The movable unit 5 may be moved by a push operation effected to the movable unit base 45, and particularly readily be moved by a push operation effected to the large-sized portion 47. Since the core 2 is typically as very small as 3 mm or around in height, so that it is not easy to operate the movable unit 5 which is a part of such small core 2. Accordingly, by configuring the movable unit 5 movable in conjunction with the push operation effected to the large-sized portion 47 having dimensions larger than those of the movable unit 5, the movable unit 5 may readily be moved.

The push operation against the movable unit base 45 (or the movable unit 5) may preferably be effected, by using a L-shaped rod jig, for example. By pushing the movable unit base 45 (or the movable unit 5) with the end of thus-kinked jig, the operation for moving the movable unit 5 may preferably be effected from the side opposite to the circuit substrate 6, with reference to the transmission-line transformer 1. In other words, it may be understood that the movable unit 5 is provided at a position accessible for the moving operation from the side opposite to the circuit substrate 6 with reference to the transmission-line transformer 1.

In this embodiment, the female threaded portion 12 is not necessary, and is therefore not formed in the body 4.

According to the second embodiment described in the above, the movable unit 5 is disposed in the guide way 41 which is formed in the body 4, and is movable along the guide way 41 by the push operation, so that the impedance characteristics of the transmission-line transformer 1 may be tunable to desired values by moving the movable unit 5 relative to the body 4. In addition, the position of the movable unit 5 and the impedance characteristics may unequivocally be corresponded for each transmission-line transformer 1. In other words, the same position of the movable unit 5 gives the same impedance characteristics in a highly reproducible manner.

Also since the movable unit 5 is disposed at a position accessible for the moving operation from the side opposite to the circuit substrate 6 with reference to the transmission-line transformer 1, so that the operability of the movable unit 5, that is, the operability in the process of tuning the impedance characteristics may further be improved, and so that the degree of freedom of layout of the transmission-line transformer 1 on the circuit substrate 6 may be improved.

Since the movable unit 5 configures a portion of the core 2 while leaving a route of winding of the transmission line 3 unobstructed, so that the operability of the movable unit 5 may further be improved, while suppressing a problem in that the route of winding of the transmission line 3 is affected as the movable unit 5 moves.

On the surface of the movable unit 5 on the circuit substrate 6 side thereof, the movable unit base 45 having a larger size than that of the movable unit 5 is provided in an integrated manner. More specifically, the movable unit base 45 is configured to have the small-sized portion 46 having the same size as the movable unit 5 and bonded thereto, and the large-sized portion 47 having a size larger than that of the small-sized portion 46. Therefore, the movable unit base 45 (the large-sized portion 47, in particular) may preferably be moved corresponding to the push operation.

On the surface of the body 4 on the circuit substrate 6 side, the base (body base) 7 is provided in an integrated manner. Since the movable unit base 45 is disposed in the base guide way 48 formed in the base 7, and movable along the base guide way 48, so that the movable unit base 45 may smoothly be moved.

In addition, by virtue of the flatness of the top surface of the core 2 over the entire range thereof, automatic mounting in this embodiment using an automatic mounter may be easier than in the first embodiment.

Also machining of the core 2 is easier than in the first embodiment, since there is no need of forming the female threaded portion 12 in the body 4 in this embodiment.

### Third Embodiment

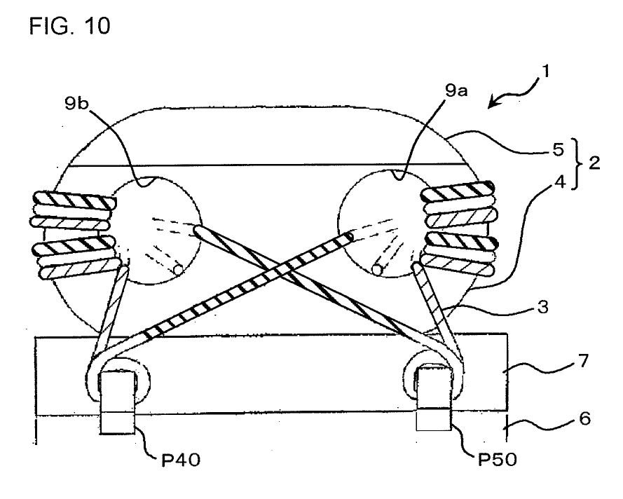

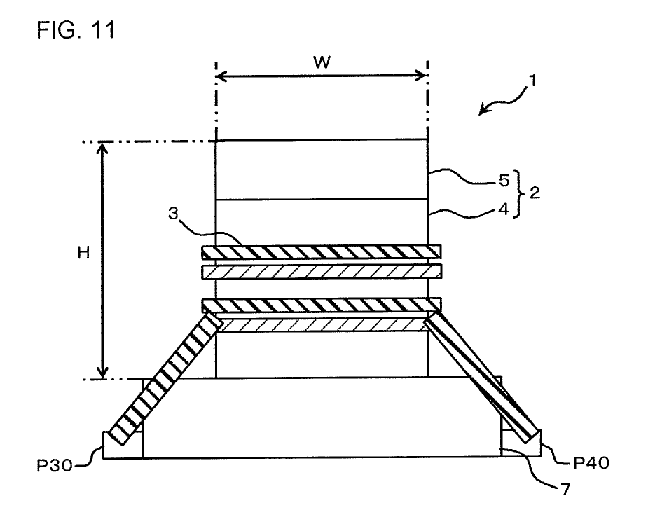

FIG. 10 and FIG. 11 are drawings illustrating a configuration of the transmission-line transformer 1 of a third embodiment. FIG. 10 is a front elevation, and FIG. 11 is a side elevation.

The transmission-line transformer 1 of the third embodiment is configured similarly as the transmission-line transformer 1 of the first embodiment, except for a configuration of the core 2.

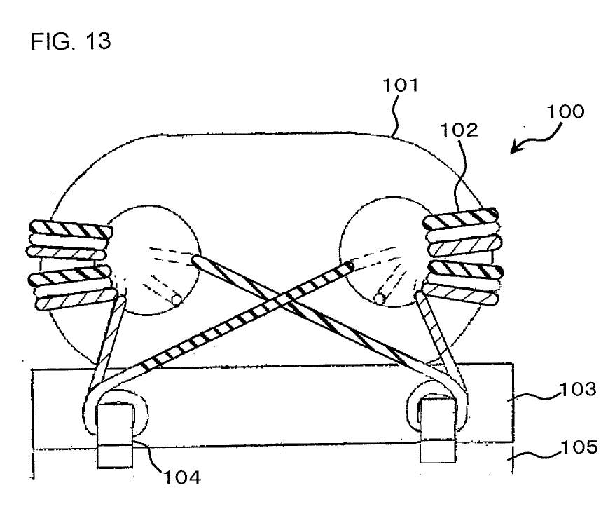

As illustrated in FIG. 10 and FIG. 11, the movable unit 5 of this embodiment is disposed on the body 4, so as to be movable along the top surface of the body 4. More specifically, as illustrated in FIG. 10 and FIG. 11, the movable unit 5 has a geometry of the upper portion of the core 101 illustrated in FIG. 13 as if it is horizontally cut therefrom, and the body 4 has a geometry of the remainder. Accordingly, the entire portion of the movable unit 5 is located on the opposite side of the circuit substrate 6, while placing the body 4 in between.

The movable unit 5 is, therefore, configured to move in any arbitrary direction along the top surface of the body 4. More specifically, the movable unit 5 may readily be moved relative to the body 4, by pushing or pulling the movable unit 5.

The body 4 in this embodiment has no female threaded portion 12 formed therein, since it is not necessary.

Since the movable unit 5 in the third embodiment is disposed on the body 4 so as to be movable along the top surface thereof, so that the impedance characteristics of the transmission-line transformer 1 may be tunable to desired values by moving the movable unit 5 relative to the body 4. In addition, the position of the movable unit 5 and the impedance characteristics may unequivocally be corresponded for each transmission-line transformer 1. In other words, the same position of the movable unit 5 gives the same impedance characteristics in a highly reproducible manner.

As illustrated in FIG. 10 and FIG. 11, the entire portion of the removable unit 5 is located on the opposite side of the circuit substrate 6 while placing the body 4 in between, and the movable unit 5 may be moved relative to the body 4 by an operation effected thereto. In other words, the movable unit 5 is provided at a position accessible for the moving operation from the side opposite to the circuit substrate 6 with reference to the transmission-line transformer 1. Therefore, the operability of the movable unit 5, that is, the operability in the process of tuning the impedance characteristics may further be improved, and the degree of freedom of layout of the transmission-line transformer 1 on the circuit substrate 6 may be improved.

As illustrated in FIG. 10 and FIG. 11, since the movable unit 5 configures a portion of the core 2 while leaving a route of winding of the transmission line 3 unobstructed, so that the operability of the movable unit 5 may further be improved, while suppressing a problem in that the route of winding of the transmission line 3 is affected as the movable unit 5 moves.

In addition, by virtue of the flatness of the top surface of the core 2 over the entire range thereof, automatic mounting in this embodiment using an automatic mounter may be easier than in the first embodiment.

Also machining of the core 2 is easier than in the first embodiment, since there is no need of forming the female threaded portion 12 in the body 4 in this embodiment.

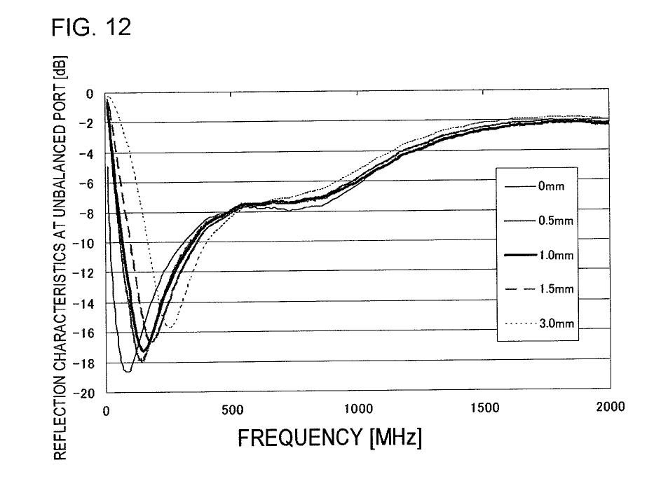

Now the transmission-line transformer 1 of the third embodiment was actually configured, and changes in the reflection characteristics were evaluated. Results are shown in FIG. 12. In the evaluation, a position of the body 4 was fixed, and the movable unit 5 was moved back and forth (in the direction of the center axis of the openings 9a, 9b). The core 2 was typically 3.0 mm in width W (FIGS. 11), and 3.0 mm also in height H (FIG. 11). The amount of movement of the movable unit 5 was varied in five steps: 0 mm (not moved), 0.5 mm, 1.0 mm, 1.5 mm, and 3.0 mm (no movable unit 5).

Assuming each of the impedance values Zin1 and Zin2 between the adjacent terminals on the balanced side, shown in the circuit diagram of FIG. 6, as 150Ω, it is known from FIG. 12 that the reflection characteristic Zout0 (impedance value=75Ω) between terminals on the unbalanced side varies depending on the position of the movable unit 5, mainly in a low-frequency range (under 500 MHz). In other words, a frequency range where changes in the geometry of the core 2 strongly affects the characteristics of the transmission-line transformer 1 is supposed to reside in a range of approximately 500 MHz or below. In contrast, in a high-frequency range exceeding 500 MHz, the impedance is supposed to hardly vary depending on changes in the characteristics of the core 2, since the characteristics may readily vary more strongly by the geometry, thickness or length of the transmission line 3, thickness of the coverage, relative position of the lines, relative position with respect to the circuit substrate 6, and so forth.

Note that the head 11 of the movable unit 5 in the first embodiment may alternatively be configured not to project out from the body 4, so that also the head 11 may be screwed into the female threaded portion 12. This configuration further facilitates the automatic mounting using a automatic mounter. Also in this configuration, the movable unit 5 may be operated from the side opposite to the circuit substrate 6 with reference to the transmission-line transformer 1.

In the third embodiment, the movable unit 5 may alternatively be configured so as to be guided by the body 4 in only one direction. For example, the movable unit 5 may be guided by the body 4, by forming a groove to the body 4, and by forming a projection which is engageable with the groove to the movable unit 5.

It is apparent that the present invention is not limited to the above embodiments, that may be modified and changed without departing from the scope and spirit of the invention.

What is claimed is:

1. A transmission-line transformer comprising:
a core composed of a magnetic substance; and
a transmission line;
said core comprising:
a body having said transmission line wound therearound; and,
a movable unit which can move relative to said body in keeping contact therewith,
wherein said transmission-line transformer is provided on a substrate,
at least a portion of said movable unit is located on the opposite side of said substrate, while placing the body in between, and
said movable unit is moved relative to said body, by an operation effected to at least said portion.

2. The transmission-line transformer according to claim 1,
wherein said movable unit is screwed into said body, while being adjusted in the position thereof relative to the body, by controlling the depth of screwing.

3. The transmission-line transformer according to claim 1,
wherein said movable unit has an adjusting operation unit for adjusting the position relative to said body, at the end thereof opposite to said substrate.

4. The transmission-line transformer according to claim 1,
wherein said movable unit is placed on said body, so as to be movable along the top surface of said body.

5. A transmission-line transformer comprising:
a core composed of a magnetic substance; and
a transmission line;
said core comprising:
a body having said transmission line wound therearound; and,
a movable unit which can move relative to said body in keeping contact therewith,
wherein said movable unit is disposed in a guide way which is formed in said body, so as to be movable along said guide way by a push operation.

6. The transmission-line transformer according to claim 5,
wherein said transmission-line transformer is provided on a substrate,
said movable unit has, on the surface thereof on said substrate side, a movable unit base which has a portion having a larger dimension than that of said movable unit, while being integrated with the movable unit, and
said movable unit is movable by a push operation to said movable unit base.

7. The transmission-line transformer according to claim 6,
said body has, on the surface thereof on said substrate side, a body base while being integrated with said body, and
said movable unit base is disposed in a base guide way which is formed in said body base, so as to be movable along said base guide way.

8. The transmission-line transformer according to claim 6,
wherein said movable unit base comprises a small-sized portion which has the same dimension with said movable unit and connected to said movable unit, and a large-sized portion which has a larger dimension than said small-sized portion has.

9. A transmission-line transformer comprising:
a core composed of a magnetic substance; and
a transmission line;
said core comprising:
a body having said transmission line wound therearound; and,
a movable unit which can move relative to said body in keeping contact therewith,
wherein said transmission-line transformer is provided on a substrate, and
said movable unit is provided at a position accessible for a moving operation from the side opposite to said substrate with reference to the transmission-line transformer.

10. The transmission-line transformer according to claim 1,
wherein said movable unit configures a portion of said core while leaving a route of winding of said transmission line unobstructed.

11. An amplifier unit comprising:
a transmission-line transformer; and
a wide-band amplifier connected to said transmission-line transformer;
said transmission-line transformer comprising:
a core composed of a magnetic substance; and
a transmission line;
said core comprising:
a body having said transmission line wound therearound; and,
a movable unit which can move relative to said body in keeping contact therewith,
wherein said transmission-line transformer is provided on a substrate,
at least a portion of said movable unit is located on the opposite side of said substrate, while placing the body in between, and
said movable unit is moved relative to said body, by an operation effected to at least said portion.
